(19) United States
(12) Patent Application Publication
(10) Pub. No.: US 2004/0228629 A1
(43) Pub. Date: Nov. 18, 2004

(54) Fast-switching scalable optical interconnection design with fast contention resolution

(76) Inventors: James M. Harris, Elmira, NY (US); Brewster R. Hemenway JR., Painted Post, NY (US); Frederic Quan, Bath, NY (US); David W. Smith, Campsea Ash (GB)

Correspondence Address: CORNING INCORPORATED, SP-TI-3-1, CORNING, NY, 14831

(21) Appl. No.: 10/729,556

(22) Filed: Dec. 4, 2003

Related U.S. Application Data
(60) Provisional application No. 60/431,063, filed on Dec. 4, 2002.

(51) Int. Cl. H04J 14/02

(52) U.S. Cl. 398/79

(57) ABSTRACT

A scalable optical interconnect includes a plurality of transmitters, a multiplexing subsystem able to combine the signals of the plurality of transmitters onto one or more transport fibers according to an orthogonal multiplexing scheme, multiple broadband burst-mode receivers structured and positioned so as to be capable of receiving any signal from any one transmitter of the plurality of transmitters, a distribution subsystem structured so as to be able to distribute independently and contemporaneously the signals of every transmitter to every receiver; and one or more selection subsystems structured and arranged so as to be capable of selecting, in less than 1 microsecond, a single channel from within the orthogonal multiplexing scheme. A method and architecture for distributed contention resolution is also disclosed.

### CROSS-REFERENCE TO RELATED APPLICATIONS

This application claims the benefit of priority under 35 U.S.C. § 119(e) of U.S. Provisional Application Serial No. 60/431063 filed on Dec. 4, 2002.

### BACKGROUND OF THE INVENTION

1. Field of the Invention

The present invention relates generally to high-bandwidth, high-speed optical interconnection systems and particularly to fast-switching or optical packet switching optical communications or interconnection systems with fast, efficient contention resolution.

2. Technical Background

As communications and interconnection systems increase in power and flexibility, the capabilities of electronic components are challenged. With increasing bit rates, management of power consumption, impedance, and crosstalk becomes significantly difficult. Many electronic processors in parallel can handle high bit rates, but, with increasing interconnection or network performance, the complexity of the resulting electronic architectures as a whole, and the power consumption of the parallel processors and supporting devices, becomes difficult to manage. Also, in a highly parallel system with high degree of interconnection high bit rates, contention resolution or scheduling can become a bottleneck.

Optical interconnection and communication systems offer the ability to achieve higher performance levels with less structural and logical complexity, less power consumption, and resulting greater reliability. Particularly in managing information flows such as those required by the interconnected parallel processing architectures of highly parallel supercomputers, high-speed-switchable optical interconnections are preferable to electronic interconnections and to electronically switched optical interconnections. Yet even in the optical domain, as the number of nodes and the supported data rates increase, contention resolution or the orderly and efficient control of information or packet flows becomes a daunting task.

### SUMMARY OF THE INVENTION

The present invention provides an optical interconnection architecture, for synchronizable optical interconnections or networks, that is highly scalable to large numbers of ports at maximum data rates. This scalability is related significantly to the structure of the architecture which facilitates the contention resolution or the orderly control of the flow of data through the interconnection.

According to one aspect of the present invention, a scalable optical interconnect is provided that includes a plurality of transmitters, a multiplexing subsystem structured and arranged so as to be able to combine the signals of the plurality of transmitters onto one or more transport fibers according to an orthogonal multiplexing scheme, broadband burst-mode receivers structured and arranged so as to be capable of receiving any signal from any one transmitter of the plurality of transmitters, a distribution subsystem structured and arranged so as to be able to distribute independently and contemporaneously the signals of every transmitter to every receiver; and one or more selection subsystems structured and arranged so as to be capable of selecting, in less than 1 microsecond, a single channel from within the orthogonal multiplexing scheme.

According to another aspect of the present invention, a scalable optical interconnect is provided that is capable of transparent optical switching at switching speeds of less than one microsecond along all of at least two orthogonal switching dimensions. Desirably but not necessarily, these at least two dimensions include space and wavelength.

According to still another aspect of the invention, a scalable optical interconnect includes a plurality of local transmitters, a bit clock providing a bit clock signal to the plurality of transmitters, a 10-nanosecond or faster switch for selecting among said plurality of transmitters, and burst-mode receivers structured and arranged so as to receive bursts of data from said local transmitters through said switch, whereby the burst-mode receivers need only acquire a bit phase associated with each burst of data, and not a bit frequency, not a bit frequency and a bit phase together.

According yet another aspect of the present invention, there is provided a distributed scalable contention resolution and resource scheduling subsystem including a plurality of input control channels, a plurality of output control channels, a plurality of logical processes distributed over one or more processors, a first process of said logical processes dedicated to resolving contentions among signals from transmitters contending for a first subset of shared resources, a second process of said logical processes dedicated to resolving contentions among signals from transmitters contending for a second subset of shared resources within an optical interconnect, based in part on output from said first process, and wherein the first subset and the second subset are independently multiplexible and selectable.

According to yet another aspect of the present invention, there is provided a method of contention resolution and resource scheduling within an optical interconnect, the method comprising the steps of resolving contentions among signals from transmitters contending for a first subset of shared resources within an optical interconnect, resolving contentions among signals from transmitters contending for a second subset of shared resources within an optical interconnect, based in part on the result of resolving contentions among signals from transmitters contending for the first subset, wherein the first subset and the second subset are independently multiplexible and selectable.

Additional features and advantages of the invention will be set forth in the detailed description which follows, and in part will be readily apparent to those skilled in the art from that description or recognized by practicing the invention as described herein, including the detailed description which follows, the claims, as well as the appended drawings.

It is to be understood that both the foregoing general description and the following detailed description present embodiments of the invention, and are intended to provide an overview or framework for understanding the nature and character of the invention as it is claimed. The accompanying drawings are included to provide a further understanding of the invention, and are incorporated into and constitute a part of this specification. The drawings illustrate various embodiments of the invention and, together with the description, serve to explain the principles and operations of the invention.

### BRIEF DESCRIPTION OF THE DRAWINGS

FIG. 1 is a schematic diagram of one embodiment of an optical interconnect according to the present invention.

FIG. 2 is a schematic diagram of another embodiment of an optical interconnect according to the present invention.

FIG. 3 is a schematic diagram showing a more detailed embodiment of a portion of the embodiment of FIG. 1.

FIG. 4 is a schematic diagram of showing a more detailed embodiment of a portion of the embodiment of FIG. 1.

FIG. 5 is a schematic diagram of an embodiment of a distribution subsystem according to the present invention.

FIG. 6 is a schematic diagram of another embodiment of a distribution subsystem according to the present invention.

FIG. 7 is a schematic diagram of still another embodiment of a distribution subsystem according to the present invention.

FIG. 8 is a schematic diagram of an embodiment of an arrayed amplifier module according to the present invention.

FIG. 9 is a schematic diagram of another embodiment of an arrayed amplifier module according to the present invention.

FIG. 10 is a schematic diagram of an embodiment of a space selector according to the present invention.

FIG. 11 is a schematic diagram of an embodiment of another space selector according to the present invention.

FIG. 12 is a schematic diagram of an embodiment of a wavelength selector according to the present invention.

FIG. 13 is a schematic diagram of an embodiment of another wavelength selector according to the present invention.

FIG. 14 is a schematic diagram of an embodiment of still another wavelength selector according to the present invention.

FIG. 15 is a schematic diagram of an embodiment of yet another wavelength selector according to the present invention.

FIG. 16 is a schematic diagram of an embodiment of still another wavelength selector according to the present invention.

FIG. 17 is a schematic diagram of an embodiment of yet another wavelength selector according to the present invention.

FIG. 18 is a schematic diagram of an embodiment of a selection leg utilizing a wavelength band.

FIG. 19 is schematic diagram of another embodiment of a selection leg utilizing a wavelength band.

FIG. 20 is schematic diagram of still another embodiment of a selection leg utilizing a wavelength band.

FIG. 21 is a schematic diagram of a multi-stage orthogonal optical interconnect according to an embodiment of the present invention.

FIG. 22 is a schematic diagram of a distributed contention resolution process and processor according to an embodiment of the present invention.

FIG. 23 is a diagram of a process carried out by the distributed contention resolution process and processor of FIG. 22 according to an embodiment of the present invention.

### DETAILED DESCRIPTION OF THE PREFERRED EMBODIMENTS

The present invention provides a practical, robust architecture for a scalable, fast switching (minimal-latency packet switching) optical interconnect, and an apparatus and method for fast, scalable contention resolution in such an interconnect. An “interconnect” or “interconnection” as used herein is not restricted to a particular distance or geography, but the interconnection of the present invention is optimized and intended for synchronous operation and capable of optical packet routing at high data rates.

In the present preferred embodiment(s) of the invention described below in connection with the accompanying drawings, whenever possible, the same reference numerals will be used throughout the drawings to refer to the same or like parts.

A fundamental unifying principle in switch architectures and methods of the type of the present invention is the use of multiplexing and high-speed switching in multiple orthogonal domains. At the minimum level, two domains, desirably space (waveguide or fiber) and wavelength, are employed. Utilizing two domains of M fibers and N wavelengths, M×N information senders (“sources”) and M×N information receivers (“sinks”) can be interconnected in a non-blocking fashion. In such a two-domain, fiber-and-wavelength multiplexed interconnect, the switching function or the “selectivity” for fiber can be located near the sources or near the sinks, and the selectivity for wavelength can also be located near the sources or near the sinks, as illustrated by the following examples.

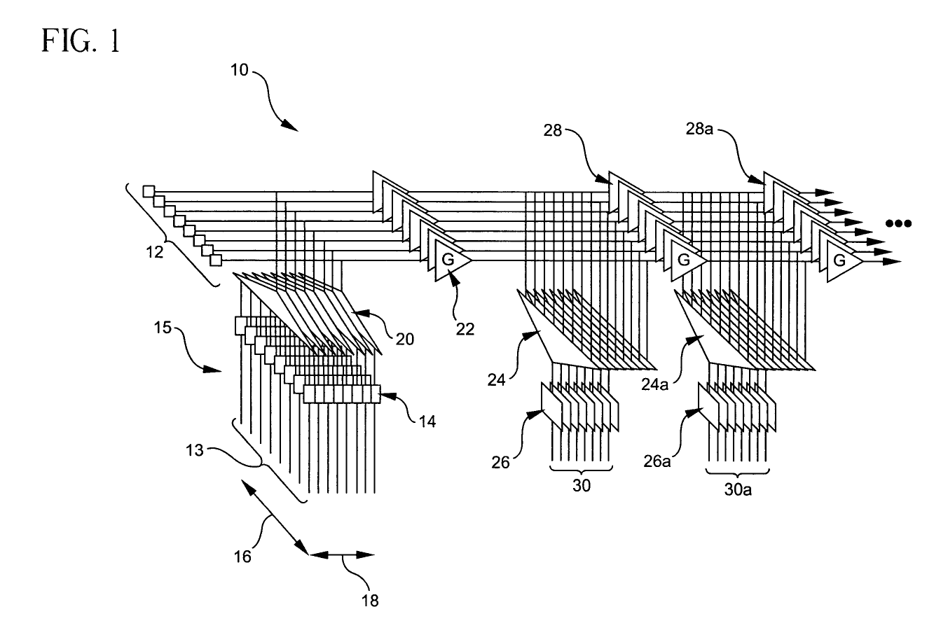

FIG. 1 shows a diagram of a two-domain (fiber-wavelength) interconnect 10, useful in the context of the present invention, in which both fiber selectivity and wavelength selectivity are located at the sink side, as opposed to the source side. A total of M transport fibers 12 (M=8 in the figure) are utilized to transmit information from multiple sources represented in the figure by an array of modulators 14. Each modulator in the array of modulators 14 is fed unmodulated light by a fiber in an array of fibers 15. Each modulator is assigned one of N colors (N=8 in the figure), each color carried to the respective modulator by the respective associated fiber of the array of source fibers 15, the rows of different colors being indicated in the figure by the reference character 13). Each modulator is also assigned (multiplexed on) to one of the transport fibers 12 by one of multiplexers 20. The array of modulators 14 and the array of feeding fibers 15, as shown in the figure, is thus an 8×8 array, multiplexed by color (wavelength) in the direction 16 indicated in the figure, and by fiber (corresponding to the fibers 12) in the direction 18 indicated in the figure. Thus each source, through its corresponding modulator, is assigned a unique fiber-wavelength coordinate pair. The task of the selection legs on the sink or receiving side of the interconnect, as described below, is thus to be able select, for each selection leg, any one of the fiber-wavelength coordinates at any time, independently of any other sink.

The modulators of modulator array 14 may alternatively be self-contained sources, such as self-contained laser-plus-modulator devices, or directly modulated lasers. It is desirable in some cases for the modulators to be external to the source to allow for the flexibility changing the color of a given source, under control of the interconnect control system or the local node associated with the source. External modulation also generally performs better, i.e., is faster, and has less chirp or other nonlinearities, than direct modulation.

The fiber-color multiplexed signals from the modulators of the array of modulators 14 are optionally amplified by amplifiers 22 if needed, then are tapped off to eight different selection legs 30. For each respective selection leg of the selection legs 30, M taps, one from each of the fibers 12, are fed to a respective space switch of an array of space switches 24. The respective space switch of the array of space switches 24 selects from which of the M tap lines to receive signals, and passes the signals on to a respective wavelength selector of the array of wavelength selectors 26. The wavelength selector selects which of the N wavelengths to receive at the respective selection leg 30. Thus each selection leg of the selection legs 30 can select to receive from any of the M×N modulators of the array of modulators 14.

In the embodiment of FIG. 1, for each of the fibers 12, the amount of signal not tapped off by the eight taps for the eight selection legs 30 is then amplified by a respective one of the amplifiers 28, so as to provide signal power for another 8 selection legs 30A to likewise select any of the M×N fiber-wavelength coordinates via space switches 24A and wavelength selectors 26A. After further amplification by amplifiers 28A, the signals on fibers 12 encounter a repetition of the selection leg structures as suggested by the ellipses in the figure. Desirably, a sufficient number of additional selection legs above those actually shown in the figure are provided, so as to allow for a full M×N architecture of sources and sinks, with each sink having one, desirably two or more selection legs.

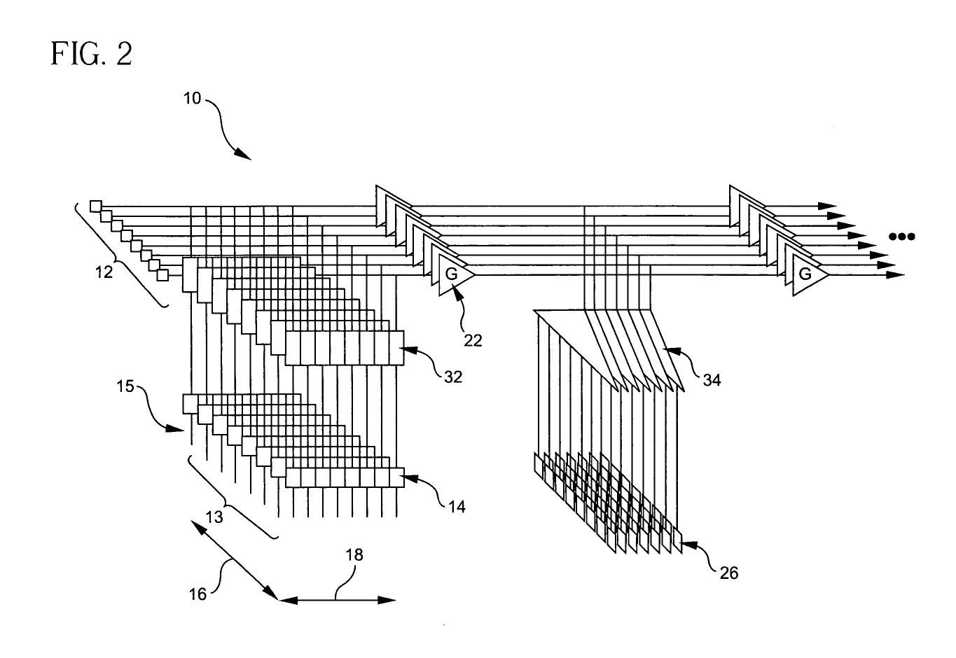

In the embodiment of FIG. 1, and the embodiment of FIG. 2 to be next described, the signal distribution scheme along the N interconnect fibers 12 to the selection legs is a basic bus architecture. However, it should be noted that this is far from the only alternative. Other architectures for distributing the signals from the N interconnect fibers 12 to the selection legs will be described below.

FIG. 2 shows a diagram of an alternate two-domain (fiber-wavelength) interconnect 10, in which fiber selectivity is located on the source side and wavelength selectivity is located at the sink side. A total of M fibers 12 are utilized to transmit information from M×N sources represented in the figure by an array of modulators 14. Each modulator in the array of modulators 14 is fed unmodulated light by a fiber in an array of source fibers 15. Each modulator is assigned one of N colors, each color carried to the respective modulator by the respective associated fiber of the array of source fibers 15, the rows of different colors being indicated in the figure by the reference character 13. Signals from each modulator are selectively routed onto a selected one of the fibers 12 by one of M×M space switches 32, of which there are N in total. The array of modulators 14 and the array of source fibers 15, as shown in the figure, is thus an M×N array, multiplexed by color (wavelength) in the direction 16 indicated in the figure, and by fiber in the direction 18 indicated in the figure. The difference from the architecture of FIG. 1 lies in the fact that the fibers of array of source fibers 15 are not mapped in a fixed pattern onto the M fibers 12, but are each selectively routed in the dimension along the direction 18 onto a selected one of the M fibers 12. Thus each source, through its corresponding modulator, is assigned a unique wavelength but is routable on the source side to a selected fiber. The task of the sink or receiving side of the interconnect is thus to the capability to select, at each selection leg, any one of the wavelengths at any time, independently of any other selection leg.

The fiber-routed and color-multiplexed signals from the modulators of the array of modulators 14 are amplified by amplifiers 22, then are tapped off to eight eight-way splitters 34. Each of the eight split paths carries all wavelengths to a respective wavelength selector of an array of wavelength selectors 26. Each sink is thus located at a specific fiber address. Each source is assigned a specific color, and the associated space switch 32 chooses the fiber of fibers 12 that will transmit signals from that source. For each sink, the respective wavelength selector of the wavelength selectors 26 selects which wavelength to receive. Thus each of sixty-four (64) total sinks can effectively select to receive from any of the sixty-four (64) modulators of the array of modulators 14.

The reader will recognize that alternate embodiments could have wavelength selectivity on the source side and fiber selectivity on the sink side, or both wavelength and fiber selectivity on the source side, with merely passive, single-wavelength receivers on the sink side.

More significantly, architectures of these types can also be expanded into more than two orthogonal domains. For example, wavelength, space, and time domains can be used orthogonally for further multiplexing. Polarization, particularly the two dominant polarization modes such as in a single-mode polarization-maintaining fiber, can also be used as another orthogonal dimension for still further multiplexing. Interestingly, as explained in greater detail below, the wavelength domain can be subdivided into wavelength bands and wavelength channels within the bands, and both wavelength bands and wavelength channels can function as separate orthogonal dimensions within the interconnect. Indeed, as will be explained below, it is presently preferred to use at least three orthogonal domains in the interconnect of the present invention, over and above the time domain.

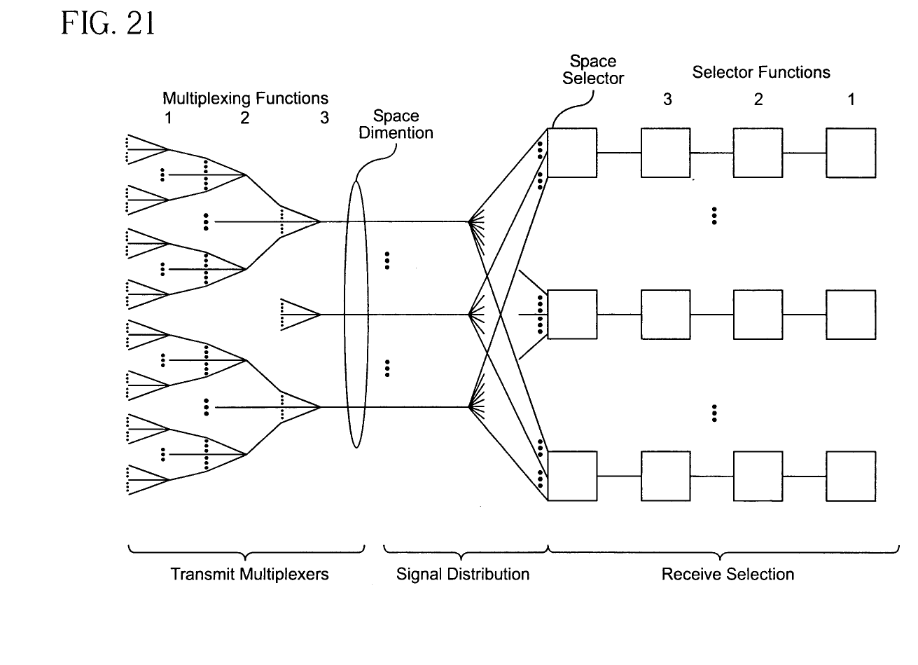

An interconnect similar to that of FIG. 1 above, but generalized to four orthogonal dimensions, is represented schematically in FIG. 21. At the left of the figure are the transmit multiplexers which combine, in succeeding statges, data channels spread over dimensions 1, 2, and 3, possibly representing, for example, wavelengths, wavebands, and polarization or, as a further example, wavelengths, narrowly spaced wavebands, and broadly spaced wavebands. The first three dimensions are then multiplexed over a space dimension (if more than one space dimension is desired), completing the multiplexing. The multiplexed signals are then independently distributed to all selectors (or selection legs) via a broadcast network (essentially an all-pass splitter). Each selection leg includes, desirably first in order, a space selector that selects the entire content of a given space dimension and passes that content to the remainder of the selection leg. Selector functions 3, 2, and 1 then successively down-select from the remaining contents to a single channel until the desired content is all that remains on that leg. Each selection leg can select content independently of all other selection legs.

Presently most preferred are architectures of the type in FIG. 1 wherein all selectivity is implemented at the sink side of the interconnect. This facilitates just-in-time control of switching for high-speed packet routing and potentially allows for unlimited multicasting. Achievable scaling by number of nodes with 40 Gbit/sec streams is shown in TABLE I below.

TABLE I
NUMBER OF NODES

| | Wavelength Count | | | | | | | |
|---|---|---|---|---|---|---|---|---|
| | 8 | | 40 | | 80 | | 96 | |
| Fiber | Polarization Count | | | | | | | |
| Count | 1 | 2 | 1 | 2 | 1 | 2 | 1 | 2 |
| 8 | 64 | 128 | 320 | 640 | 640 | 1280 | 768 | 1536 |
| 48 | 384 | 768 | 1920 | 3840 | 3840 | 7680 | 4608 | 9216 |
| 96 | 768 | 1536 | 3840 | 7680 | 7680 | 15360 | 9216 | 18432 |

As the reader will recognize, if lower bit rates per sink are acceptable, multiplexing in the time dimension can multiply the node counts of Table I significantly. This capability would be used, for example, when each node represents the aggregate demands of a small number of users such as a neighborhood of people or a local network of CPUs.

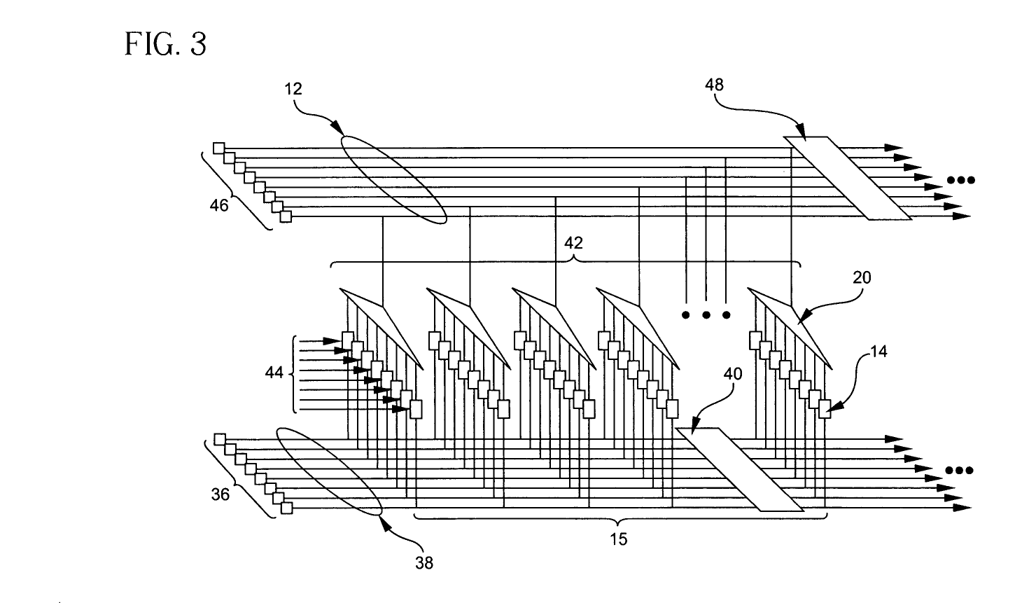

It is desirable in interconnects of the type in FIG. 1 to employ a shared array of continuous wave (“CW”) WDM sources to feed the fiber array 15 of FIG. 1. The diagram of FIG. 3 shows more detail of the source side of the interconnect of FIG. 1, including an array 36 of continuous wave WDM sources. Commercially available distributed feedback lasers (“DFB” lasers) are desirable for array 36. These sources provide high-quality CW light, which is carried from the array 36 by source distribution fibers 38 and conveyed through taps to the fibers of the fiber array 15. An arrayed single-channel amplifier module 40 may be used if desired to maintain adequate power in the distribution fibers 36 in a particularly large-scale embodiment. The sources for each fiber can be grouped into multiple source modules 42, each including the modulators 14 for a respective fiber of fibers 12, and a multiplexer (or combiner) 20. A wavelength multiplexer is preferred where highest performance is desired, as the wavelength multiplexer acts to filter any out-of-band noise from the modulators 14 and other sources. Data sources 44 (shown for one source module only) are fed to the modulators 14, which are desirably high-speed electro-absorptive (“EA”) modulators, or high-speed electro-optic (“EO”) modulators. The laser source array 36, though typically thermo-electrically stabilized, is kept spatially and thermally isolated from the relatively low power EA modulators 14, minimizing potential heat buildup at and near the modulators.

As further shown in FIG. 3, out-of-band routing data may be added to the interconnect fibers 12 by optical signal sources 46. Adequate power levels may be maintained in fibers 12 by an arrayed multi-channel amplifier module 48.

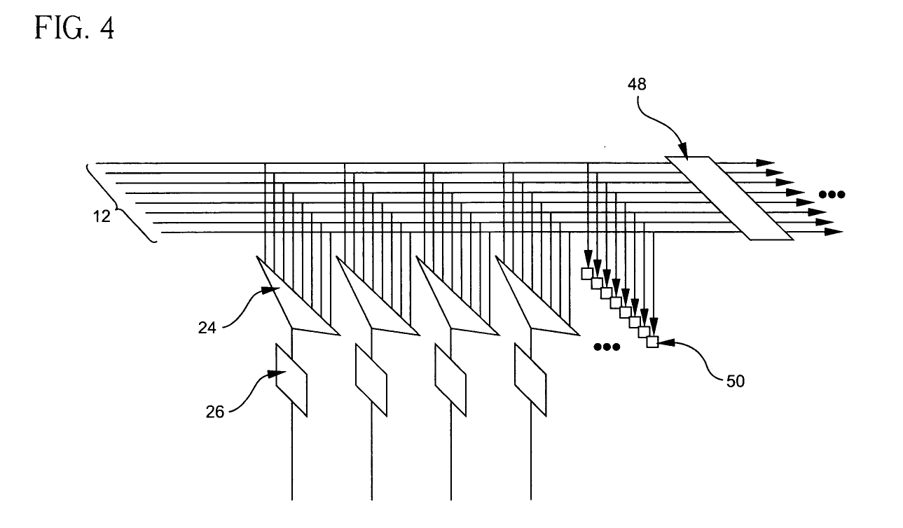

FIG. 4 shows more detail on the sink side of the interconnect 10 of FIG. 1. As shown in FIG. 4, multi-channel amplifier modules such as multi-channel amplifier module 48 may be repeated at intervals as needed within the sink side of the interconnect to preserve adequate power levels in the interconnect fibers 12. Routing data may be copied optically (such as via wavelength selective taps) and received from each bus fiber via a routing data receiver array 50.

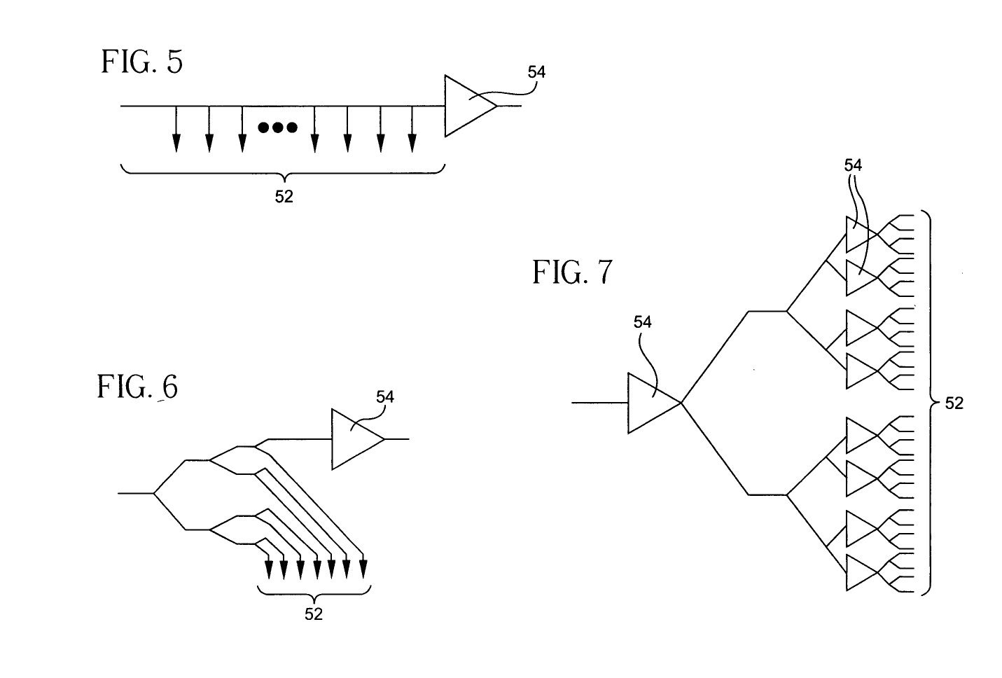

FIGS. 5-7 show three alternate embodiments distribution subsystems useful for distribution of the color source from the source distribution fibers 38 to the source fibers 15 (as shown in FIG. 3) and for the distribution of the modulate signals from interconnect fibers 12 to the selection legs 30 (as shown in FIGS. 1 and 4). Amplified versions are required only at higher node scales, and may use amplifier modules as discussed above with respect to FIGS. 3 and 4, rather than individual amplifiers. For simplicity of discussion, in FIGS. 5-7, a single fiber with a single amplifer (or with singular amplifiers) are shown in the disclosed distribution subsystem configurations. It is understood that the amplifiers shown in FIGS. 5-7 may stand for the relevant portion of an amplifier module such as those shown in FIGS. 3 and 4.

For the distribution of the color source, the number of taps required is generally equal to N, the number of wavelengths in the wavelength domain of the interconnect (the number of wavelengths per interconnect fiber). (The number of taps required or desirable for distribution of the modulated signals is generally significantly higher.) FIG. 5 shows a serial tap of N total taps 52 before amplification by amplifier 54. The ratio of the taps from left to right should then be 1:N, 1:(N−1), 1:(N−2), 1:(N−3), . . . 4:1, 3:1, 2:1, and finally 1:1 for the last. FIG. 6 shows a 1:8 star tap in which seven of the branches from local taps 52 and one of the branches is amplified by a amplifier 54 for further tapping. FIG. 7 shows a uniform loss amplified star tap, with amplifiers 54 located both prior to any splitting and distributed as needed throughout the branches of the star. This type of tapping scheme may be used for highest performance and maximum scalability, and is particularly useful on the sink or receiver side of the interconnect, where a relatively higher number of taps is generally desirable.

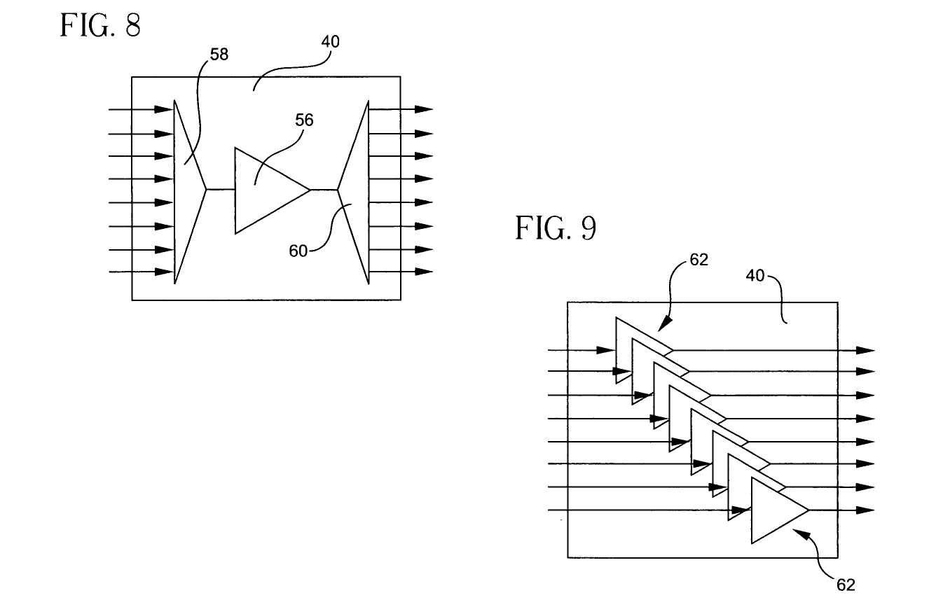

In the optical interconnects of the present invention, in order to best scale up the required amplification capability, amplifier capacity is shared where possible unless the cost in components added to facilitate sharing is greater than the reduction in amplifier costs. In particular, where arrayed amplifier modules are used, the arrayed single-channel amplifier module 40 of FIG. 3 could be realized with a single amplifier 56 fed by a combiner or multiplexer 58 and followed by a demultiplexer 60, as shown diagrammatically in FIG. 8, or by an array of single channel amplifiers 62, as shown in FIG. 9. Silicon Optical Amplifiers (“SOAs”) may be used or fiber amplifiers may be used for these and the arrayed multi-channel amplifier module 48 of FIGS. 3 and 4.

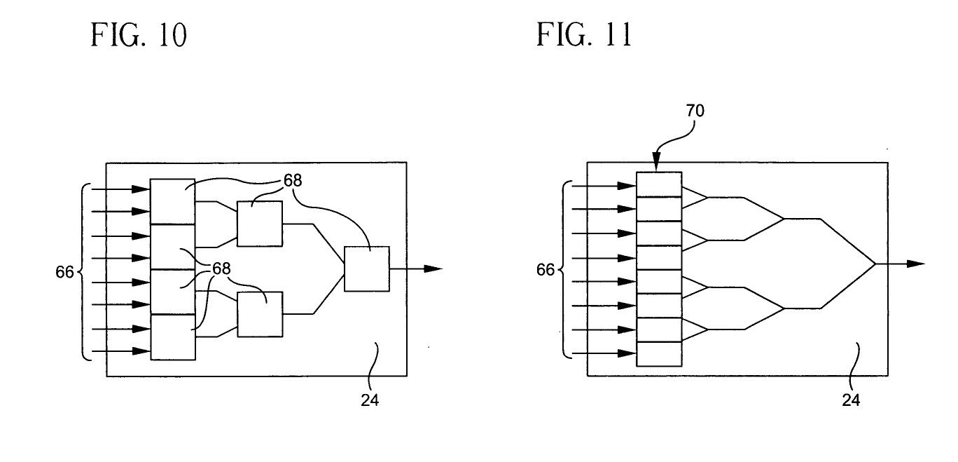

For the space select (fiber select) switches 24 in the optical interconnect 10 of FIG. 1, multi-wavelength SOA-based switches are the presently preferred technology. Attributes of preferred technology for this application include high speed, stable operation, low cost, integratibility, and especially high extinction ratio (low crosstalk) and gain. Alternatives include EO modulators, liquid crystal or phased array switches. The SOAs can be electrically or optically actuated—electrically for up to 100 ps switching speeds, and optically for faster. Two alternate configurations of the space switches 24 of FIG. 1 are shown diagrammatically in FIGS. 10 and 11. In the space select switch 24 of FIG. 10, the tap lines 66 from the interconnect fibers 12 (FIG. 1) are down-selected by a tree of 2×1 SOA switches 68. In the space select switch 24 of FIG. 11, multiple on-off SOA multi-wavelength switches 70 select which of the incoming signals on the tap lines 66 is passed. The on-off SOAs are followed by a combiner tree. Although the embodiment of FIG. 10 preserves the most signal power, the embodiment of FIG. 11 is most easily and reliably manufactured, and the SOA on-off switches provide some gain to offset the losses of the star coupler.

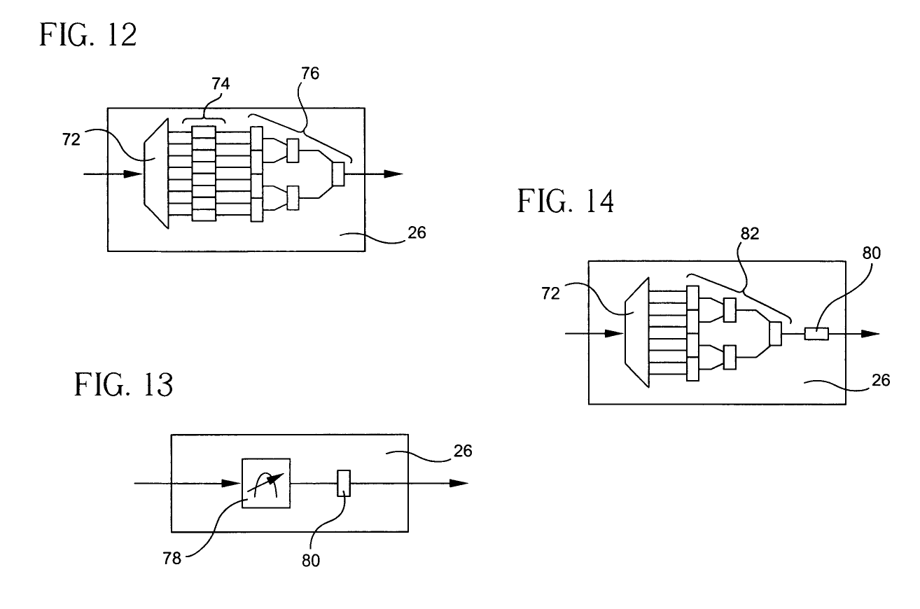

For the wavelength select switches 26 in the optical interconnect 10 of FIG. 1, there are several alternative possible embodiments, some of which are shown diagrammatically in FIGS. 12-17. FIG. 12 shows a wavelength select switch 26 having a static optical demultiplexer 72 a receiver array 74. A tree of electronic 2×1 switches 76 then selects the desired signal electronically. FIG. 13 shows a wavelength select switch 26 having a fast tunable multi-quantum well-activated multi-cavity filter (“MQW filter”) 78 followed by a single receiver 80. Where fast switches are present upstream within the interconnect, receiver 80 should be a burst-mode receiver, i.e., a receiver that can rapidly acquire the data clock frequency and phase for bit decisions. Where the transmitters of the interconnect are together in a local environment, they may be driven by the same bit rate clock. This alleviates the receivers from having to acquire both bit frequency and bit phase. In this case, the receivers only need to acquire bit phase, a function that can be performed more quickly than both bit frequency and bit phase or even than bit frequency alone, e.g., in less than two nanoseconds in the worst case (180° bit phase offset).

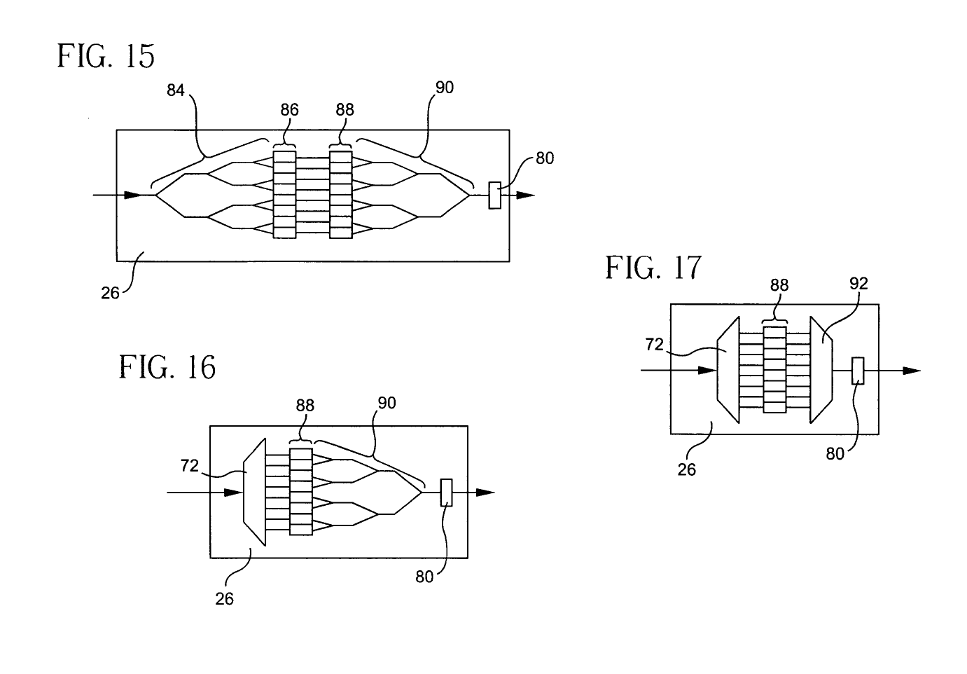

FIG. 14 shows a wavelength select switch 26 having a having a static optical demultiplexer 72 followed by an optical selector tree 82 and a single receiver 80. FIG. 15 shows a wavelength select switch 26 having a fan-out or star splitter 84 followed by an array of fixed wavelength filters 86, followed by an array of on-off SOAs 88, followed by a fan-in or combiner 90 and a single receiver 80. FIG. 16 shows a wavelength select switch 26 having a static optical demultiplexer 72 followed by a an array of on-off SOAs 88 followed by a fan-in or combiner 90 and a single receiver 80. FIG. 17 shows a wavelength select switch 26 having a static optical demultiplexer 72 followed by an array of on-off SOAs 88 followed by an optical multiplexer 92 and a single receiver 80. The embodiments employing arrays of on-off SOAs are advantageous in one respect because of the built-in gain of the SOA devices and because they use essentially constant power, since typically one of the SOA devices, and only one, will be on at all times, making power and heat management predictable. Also, tunable filters, such as that used in the embodiment of FIG. 13, even if they are very fast can exhibit ringing or overshoot upon switching to a new frequency, while the SOA based designs have no similar stability problems. The embodiment of FIG. 17 is in addition advantageous in that the optical multiplexer effectively 92 acts as a filter out-of-band noise such as ASE noise, while avoiding the losses inherent in a fan-in or combiner, and is accordingly the presently preferred embodiment.

Wavelength select switches such as those shown in the embodiments of FIGS. 12-17 may also be configured to operate in wavelength bands rather than in individual wavelength channels. There at least two reasons this may be desirable.

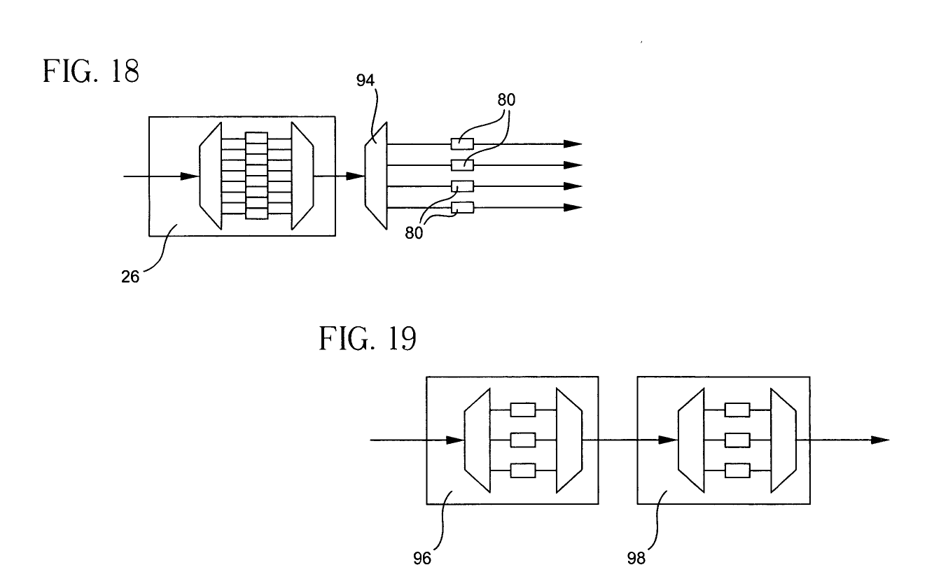

First, in the case where individual nodes demand more bandwidth than is available on a given wavelength channel, multiple channels can be routed together as a block or band of channels and be divided out only immediately prior to a receiver array at each of the respective nodes. This is illustrated diagrammatically in FIG. 18, which shows a wavelength select switch 26 as described in FIG. 17, but where each of the eight wavelengths selectable by the switch 26 are comprised of a four-channel band of wavelengths. The switch 26 is followed by an optical demultiplexer 94 that acts to separate the four channels in the band and deliver each one to a respective receiver 80. Thus the bandwidth of a given node may be quadrupled, all other things being equal. The demultiplexer must be designed such that, no matter which band of four channels it receives from the switch 26, the four received can be demultiplexed to the appropriate respective receiver 80. A widely and rapidly tunable demultiplexer could be used, but a cyclic demulitplexer is desirable for its simplicity.

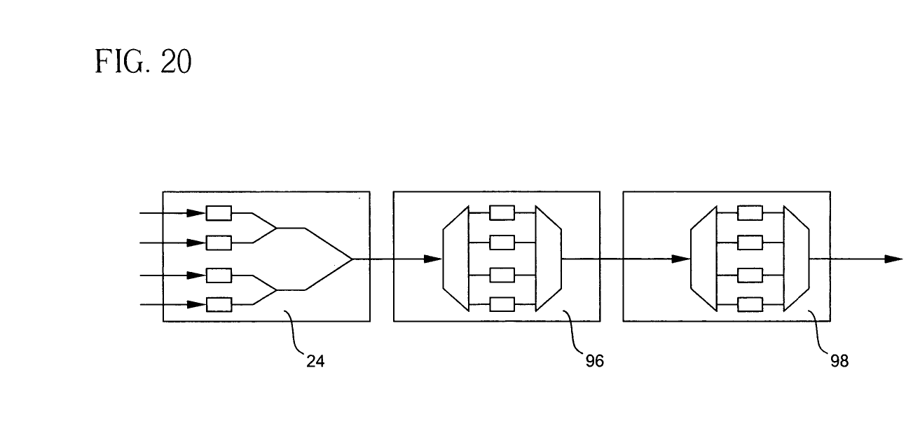

Using such widely tuneable demultiplexers or such cyclic demultiplexers, wavelength bands and wavelength channels may be switched independently and orthogonally of each other, effectively giving one or more additional orthogonal domains for the interconnect, all in the wavelength region. For example, two wavelength selective switches 96 and 98, shown in FIG. 19, may functionally take the place of the one wavelength selective switch 26 in the embodiments of FIGS. 17 or 18 (or others). This is particularly significant if it is desired to minimize the total number of SOAs because of cost or other factors. If the switch 96 is configured to operate on three wavelength bands of three channels each and the switch 98 is configured to operate cyclically over the three channels in any of the bands, then six total SOAs can provide selective access to nine channels, in comparison with eight SOAs used to provide access to eight channels in the embodiment of FIG. 17. Where on-off SOAs are used in the space switch 24 also, as shown in FIG. 11, using wavelength bands can cut the total number of SOAs even more. This is illustrated in the diagram of FIG. 20, which shows a down-selecting leg for a node of a cross connect of the type shown in FIG. 1, but with one space switch 24 followed by two wavelength switches 96 and 98 similar to those in FIG. 19. Here, the M fibers 12 of the interconnect would be only four (M=4), as reflected in the size of the space switch 24 of FIG. 20. Space switch 24 thus selects from among only four fibers. Wavelength switch 96 selects from among N wavebands on the selected fiber, with N=4, and wavelength switch 98 selects from among O wavelength sub-bands or wavelength channels in the selected waveband, with O=4, for a total number of fiber-waveband-wavelength coordinate channels M×N×O=64. Thus sixty-four sources can be distinguished at the select leg represented here (the same number as in the select legs in the embodiment of FIG. 1, but only twelve total SOAs are required across the space and wavelength switches, rather than sixteen as in the embodiment of FIG. 1.

The optical interconnects of the present invention provide several advantages. They preferably use SOAs as the active switching elements. With currently achievable SOA performance, switching speeds at and below one nanosecond are possible, with reasonably linear multiwavelength performance. The interconnect network is transparent, making it format independent, allowing multiple transmission modalities or protocols to be used, including in band (or out-of-band) forward error correction, if desired. Out-of-band optical control and clock distribution is easily provided for with modest additional complexity. Scalability is excellent, particularly with judicious application of amplification throughout the architecture

Since fiber loss is functionally negligible, the receivers can be relatively distant from the associated fiber and wavelength selectors, and the modulators can be relatively far from the WDM sources. Channel and wavelength selection and/or routing can therefore be centralized functions in the interconnect, and therefore the overhead associated with setting switch states can be shared and consolidated into compact modules. A single header-monitor may be employed to set the switch-state schedule for each small cluster of receiver nodes, thereby simplifying the header processing system. The header decoder and processing system would not be all optical, as SOAs are utilized as the switching elements, which are electrically controlled.

It is advantageous that the transmitter and scheduler/controller be closely associated where possible to minimize delay (latency) in the scheduling. In the limit of high reliability transport the receiver can be far away.

### Scalable Contention Resolution Architecture and Method

Within an extremely scalable optical interconnection design as disclosed herein, it is desirable to have an equally scalable method of contention resolution, since multiple sources cannot generally transmit to a single sink at the same time.

This problem of contention resolution occurs in telecommunication and data transmission systems, computer interconnects, storage area networks, within and between Internet Protocol (IP) Routers, digital and optical cross connects, Asynchronous Transfer Mode (ATM) switches, mini and large scale supercomputers and supercomputer clusters, IP-Peering networks, in large scale data base systems, reservation systems and search engines. The architecture and method described herein is believed to enable millions of connection requests to be resolved per second across a large scale network of hundred and even thousands of nodes. Programmable algorithms ensuring guaranteed bandwidth and various levels of fairness and priority access are supported.

For large scale interconnection systems, such as those disclosed herein, and others, that may be used in IP routers, ATM switches, super computer systems etc., it is common that two or more data sources would wish to simultaneously access the same data sink. To avoid contention, at least one of the transmitters (sources) must be temporarily held back while another is granted access to the limited channel. In some cases, as in supercomputers, for example, thousands of connection requests must be processed in the same micro-second of time, and thus for 1000 nodes over 1 billion potentially contending connection requests must be resolved per second. With present day technology, no single micro-processing chip has sufficient speed, parallelism or input/output bandwidth to resolve so many contentions at the needed rate. Furthermore, as the number of nodes accessing the network rises beyond 1000 (beyond the billion-fold example above) the contention resolution function becomes more difficult for a single CR (contention resolution) processor.

The present method and architecture solves this problem by breaking down the big CR problem into smaller CR problems manageable by high performance but available CR micro-processors. The method and architecture relates to how the problem is broken down. The approach is scaleable in the number of nodes accessing the network, and is modular, meaning the size of our CR processor can grow with the size of the network by adding on sub-processor function at a time as needed. This can take place while the original CR processor is fully functioning at its capacity limit. This is called “hot-upgrade”.

Another important aspect of the approach is that it is generally recognizable in the art that while many high speed or complex problems can be segmented to multiple processors, they often must wait for memory access to occur, and have potential contention problems in the shared memory, requiring memory locking techniques which further complicate and slow processing. This present technique allows the problem to be segmented in such a way that the processing can be done in processor resident memory (local cache) only and does not require access to a shared memory region. This enables higher speed and more distributed operation and reduces the complexity of the implementation.

An interconnection matrix is a mathematical construct listing all the nodes in the network and the state or availability of interconnections among them. In a fully interconnected network, all possible entries in the matrix can be occupied by a legal connection, although perhaps not simultaneously. In a partially interconnected network, not all entries represent a possible or accessible connection. Although the interconnects described herein are fully interconnected, this contention resolution architecture and method relates to both types of networks, fully and partially interconnected. This approach is especially applicable to multi-dimensional interconnection matrices where the contention with each dimension may be resolved in turn. For an N-dimensional interconnection matrix, N stages of CR are performed successively. A worked example is shown for an optical interconnection matrix having dimensions of space (number of optical fibers in use), and frequency or wavelength bands (number of optical wavelength bands in use). This concept can be generalized to the additional dimensions of time (number of time slots in use), polarization, and even sub-partitions or sub-dimensions within a dimension such as the number of wavelengths within a band of wavelengths, or fibers within a cluster or ribbon of discrete fibers.

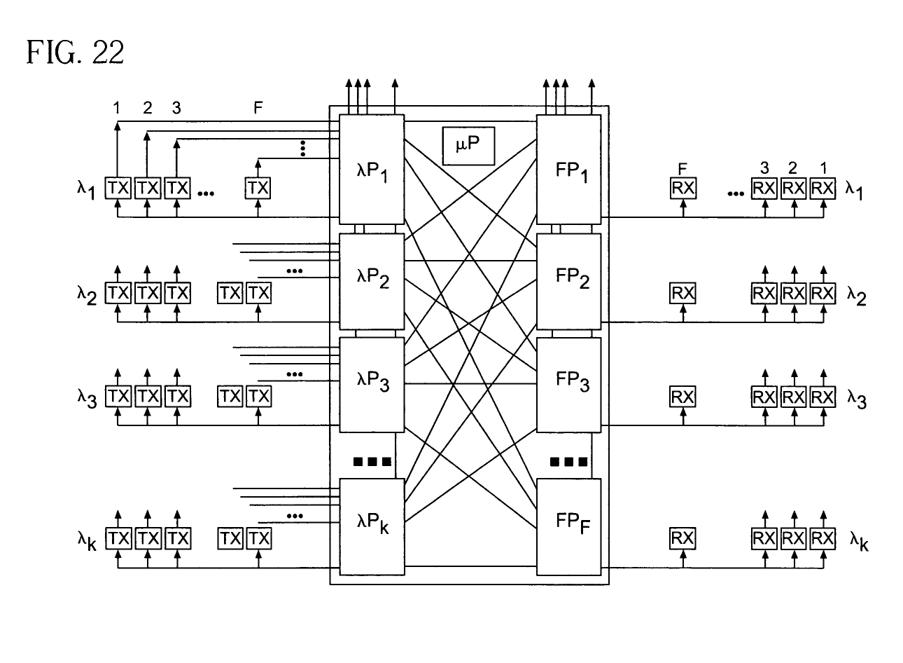

According to the inventive method of contention resolution, there are K CR-processors provided for each dimension of size K. For example, in an interconnection matrix having 2 dimensions of wavelength (say Ki wavelengths total) and fiber, say Kf fibers total), the CR processor system would consist of Ki wavelength CR processors in the first stage and Kf fiber CR processors in the second stage, as shown in FIG. 22. For a 12 fiber network having 40 wavelengths per fiber, there would be 40 wavelength processors and 12 fiber CR processors. In general, in and N-dimension interconnection network, with each dimension J having a maximum of KJ entries, a total of K1×K2×K3×K4× . . . KJ nodes may be interconnected without contention by using only K1+K2+K3+K4+ . . . KJ CR sub-processors. Each processor associated with dimension J would need to resolve only P requests simultaneously where P is the number of elements in the dimension of the preceeding stage. In the example, each wavelength CR sub-processor would resolve among only 12 fibers and each fiber processor would need to resolve only among 40 wavelengths.

In the example shown, each a single CR sub-processor is dedicated to each element in a given dimension. This allows for the highest possible performance and scaling. However, each sub-processor may be tasked to resolve contentions among multiple elements in a dimension if performance allows. For example, a sub-processor may be able to resolve 80 requests per time period, so in the example, a single CR fiber sub-processor may be tasked with resolving contentions among 2 groups of 40 wavelengths and another single CR wavelength processor may be with resolving contentions among 6 groups of 12 fibers (72 contentions <80). It is advantageous for the scheduler to have as much global knowledge as possible (i.e., to be aware of requests across as many dimensions as possible) to maximize overall scheduling efficiency.

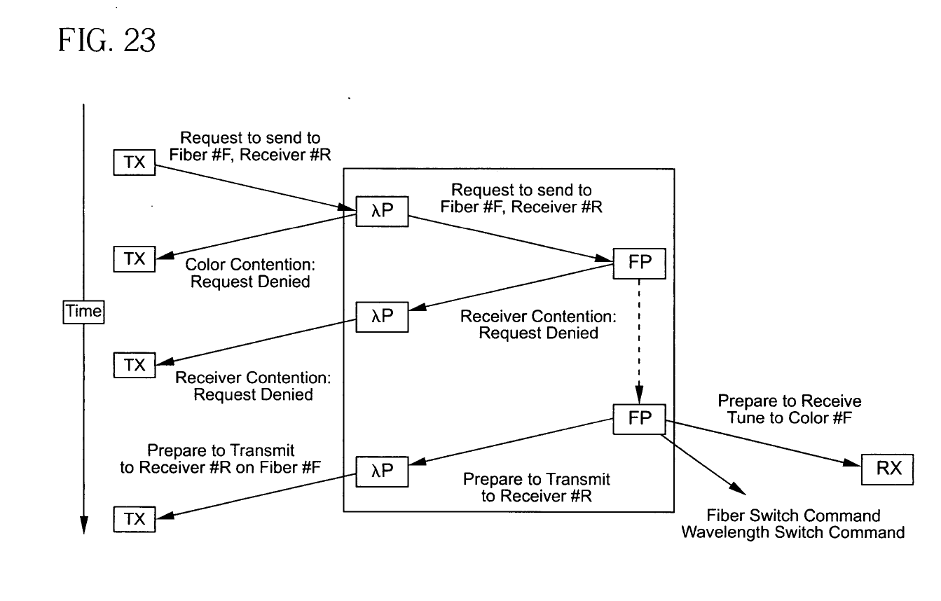

In the example, the CR algorithm may be programmable and adaptable to the specific performance required across the network. A diagram of the basic algorithm is shown in FIG. 23

Existing contention resolution systems use memory to buffer the data at intermediate points in a large interconnection matrix. Such approach works well for electronically-transferred data, up to a limit, because fast memory is easily available. However, that approach works poorly for optical interconnection systems because no or extremely limited optical buffer memory is available and often requires first-in first-out (FIFO) or serial access, not random access, so “head-of-line” blocking is a common limitation. Additionally, in these implementations, the switch designer must make some assumptions regarding the application when designing the switch to provide a buffer size appropriate to the application. Since the details of the application operating on the switch are seldom known to the switch designer, this is often not optimal. Since the present invention requires buffering at the source, the source designer must supply buffers, if they are needed, and the entire switch is not burdened by the special requirements of one application need. Multi-dimensional CR systems have been developed but these do not necessarily take advantage of true orthogonality of the dimensions of the interconnection matrix, and thus place arbitrary limits on the modularity and scaling potential of the CR system. In the case of optical interconnection matrixes, the invention takes particular advantage of easily resolvable dimensions of orthogonality. The physical implementation of the invention is particularly graceful and elegant because of its modular and orthogonal nature, and this substantially increases the scale and simplicity of the CR system.

### Latency Reduction Architectures and Methods

“Tell and Go”

In high-performance optical interconnects of the type disclosed herein, particularly where, as preferred here, a broadcast and select architecture is employed, an important reduction in latency and average transmission time may be achieved by avoiding the typical practice of a preliminary protocol exchange before first transmission of data. In other words, a transmitting node, instead of asking permission to transmit (asking whether there is contention), can simply transmit the desired packet at the same time or immediately after transmitting the routing request, without waiting for permission. If the interconnect resources are available, the transmission goes through and the only feedback from the control system is that the transmission was accepted. If the transmission could not go through, then the optical data in question is not selected—i.e., it is blocked (or unselected) at all selectors, but causes no disruption or interference of any kind—and the control system can schedule a retransmission. The effect is to remove a latency penalty on transmissions that can go through in the first attempt.

### Redundant Selection Capability

The likelihood of contention under moderate to heavy traffic loads can be significantly reduced, in interconnects of the present invention, by having redundant selection, receiving, and storage capability in each node. For a relatively small power cost (an additional 3 dB split) each node can, in effect, have two independent selection legs on the network by having at least two complete down-selection legs and two receivers. With some electronic buffering, the likelihood of success of first transmissions then increases significantly, and the overall performance of the interconnect improves.

It will be apparent to those skilled in the art that various modifications and variations can be made to the present invention without departing from the spirit and scope of the invention. Thus it is intended that the present invention cover the modifications and variations of this invention provided they come within the scope of the appended claims and their equivalents.

What is claimed is:

1. A scalable optical interconnect capable of transparent optical switching at switching speeds of less than one microsecond along all of at least two orthogonal switching dimensions.

2. The scalable optical interconnect of claim 1 capable of transparent optical switching at switching speeds of less than ten nanoseconds along all of at least two orthogonal switching dimensions.

3. The scalable optical interconnect of claim 2 capable of transparent optical switching at switching speeds of less than 100 picoseconds along all of at least two orthogonal switching dimensions.

4. The scalable optical interconnect of claim 1 capable of transparent optical switching at switching speeds of less than one microsecond along all of at least three orthogonal switching dimensions.

5. The scalable optical interconnect of claim 2 capable of transparent optical switching at switching speeds of less than ten nanoseconds along all of at least three orthogonal switching dimensions.

6. The scalable optical interconnect of claim 3 capable of transparent optical switching at switching speeds of less than 100 picoseconds along all of at least three orthogonal switching dimensions.

7. The scalable optical interconnect of claim 2 capable of transparent optical switching at switching speeds of less than ten nanoseconds along all of at least four orthogonal switching dimensions.

8. A scalable optical interconnect capable of independently transparently optically switching, at speeds of less than ten nanoseconds, from among channels distributed across space and wavelength domains.

9. The scalable optical interconnect of claim 8 capable of independently transparently optically switching, at speeds of less than ten nanoseconds, from among channels distributed across space, wavelength, and waveband domains.

10. The scalable optical interconnect of claim 8 capable of independently transparently optically switching, at speeds of less than ten nanoseconds, from among channels distributed across space, wavelength, and polarization domains.

11. The scalable optical interconnect of claim 8 capable of independently transparently optically switching, at speeds of less than ten nanoseconds, from among channels distributed across space, wavelength, waveband, and polarization domains.

12. The scalable optical interconnect of claim 8 capable of independently transparently optically switching, at speeds of less than ten nanoseconds, from among channels distributed across space, wavelength, and time domains.

13. An scalable optical interconnect comprising:
a plurality of transmitters;
a multiplexing subsystem structured and arranged so as to be able to combine the signals of the plurality of transmitters onto one or more transport fibers according to an orthogonal multiplexing scheme;
broadband burst-mode receivers structured and arranged so as to be capable of receiving any signal from any one transmitter of the plurality of transmitters;
a distribution subsystem structured and arranged so as to be able to distribute independently and contemporaneously the signals of every transmitter to every receiver; and
one or more selection subsystems structured and arranged so as to be capable of selecting, in less than 1 microsecond, a single channel from within the orthogonal multiplexing scheme.

14. An scalable optical interconnect comprising:
a plurality of local transmitters;
a bit clock providing a bit clock signal to the plurality of transmitters;
a 10-nanosecond or faster switch for selecting among said plurality of transmitters; and
burst-mode receivers structured and arranged so as to receive bursts of data from said local transmitters through said switch, whereby the burst-mode receivers need only acquire a bit phase associated with each burst of data, and not a bit frequency, not a bit frequency and a bit phase together.

15. A distributed scalable contention resolution and resource scheduling subsystem comprising:
a plurality of input control channels;
a plurality of output control channels;
a plurality of logical processes distributed over one or more processors;
a first process of said logical processes dedicated to resolving contentions among signals from transmitters contending for a first subset of shared resources;
a second process of said logical processes dedicated to resolving contentions among signals from transmitters contending for a second subset of shared resources within an optical interconnect, based in part on output from said first process; and
wherein the first subset and the second subset are independently multiplexible and selectable.

16. A method of contention resolution and resource scheduling within an optical interconnect, the method comprising the steps of:
resolving contentions among signals from transmitters contending for a first subset of shared resources within an optical interconnect;
resolving contentions among signals from transmitters contending for a second subset of shared resources within an optical interconnect, based in part on the result of resolving contentions among signals from transmitters contending for the first subset;
wherein the first subset and the second subset are independently multiplexible and selectable.
